(19) United States
(12) Patent Application Publication
(10) Pub. No.: US 2023/0397176 A1
(43) Pub. Date: Dec. 7, 2023

(54) METHODS AND APPARATUS FOR RESOURCE ALLOCATION IN A FIXED WIRELESS NETWORK

(71) Applicant: Celona, Inc., Cupertino, CA (US)

(72) Inventors: Srinivasan Balasubramanian, San Diego, CA (US); Vanlin Sathya, Cupertino, CA (US)

(21) Appl. No.: 17/883,567

(22) Filed: Aug. 8, 2022

Related U.S. Application Data
(60) Provisional application No. 63/348,417, filed on Jun. 2, 2022.

(51) Int. Cl. H04W 72/04; H04W 16/14

(52) U.S. Cl. CPC H04W 72/0453; H04W 16/14

(57) ABSTRACT

Methods and apparatus for resource allocation in a fixed wireless network are described. The resources are allocated to a BTS-CBSD based on the following input information: (1) the conditions of a Wi-Fi connection between the BTS-CBSD and each of a plurality of CPE-CBSDs; (2) the number of users being serviced by each CPE-CBSD; (3) the contention for the Wi-Fi channels at each CPE-CBSD; (4) the total amount of spectrum available to be allocated to the BTS-CBSD by the SAS/SON; (5) the achieved downlink (DL) throughput between the BTS-CBSD and the CPE-CBSD; (6) the achieved uplink (UL) throughput between the BTS-CBSD and the CPE-CBSD; and (7) the achieved latency between the BTS-CBSD and the CPE-CBSD. By using these metrics, the throughput of the Wi-Fi connection between the plurality of CPE-CBSDs and the UEs can be effectively matched to the amount of resources allocated to each CPE-CBSD and to the total amount of resources allocated to the BTS-CBSD. Based on the resources allocated to the BTS-CBSD, the supportable users/flows at the CPE-CBSDs are regulated.

### CLAIM OF PRIORITY TO PREVIOUSLY FILED PROVISIONAL APPLICATION AND INCORPORATION BY REFERENCE

This utility application claims priority to earlier-filed provisional application number 63/348,417 filed Jun. 2, 2022, entitled “Method and Apparatus for Resource Allocation in a Fixed Wireless Network” (ATTY. DOCKET NO. CEL-080-PROV); and the above-cited earlier-filed provisional application number 63/348,417 is hereby incorporated by reference herein as if set forth in full.

### BACKGROUND

### (1) Technical Field

The disclosed methods and apparatus relate generally to resource allocation in a wireless network, and in particular, to resource allocation in a fixed wireless network.

### (2) Background

The wireless industry has experienced tremendous growth in recent years. Wireless technology is rapidly improving, and faster and more numerous broadband communication networks have been installed around the globe. These networks have now become key components of a worldwide communication system that connects people and businesses at speeds and on a scale unimaginable just a couple of decades ago. The rapid growth of wireless communication is a result of increasing demand for more bandwidth and services. This rapid growth is in many ways supported by standards. For example, 4G LTE has been widely deployed over the past years, and the next generation system, 5G NR (New Radio) is now being deployed. In these wireless systems, multiple mobile devices are served voice services, data services, and many other services over wireless connections so they may remain mobile while still connected.

The 5G (fifth generation New Radio) network, includes user equipment (UE) 101 that communicates with a base station/access point (BS/AP) 103 as shown in the wireless communication network 100 of FIG. 1. The term UE refers to a wide array of devices having wireless connectivity, such as a cellular mobile phone, Internet of Things (IoT) device, virtual reality googles, robotic device, autonomous driving machine, smart barcode scanner, and communications equipment. Communications equipment includes desktop computers, laptop computers, tablets and other types of personal communications devices.

FIG. 1 is an illustration of components of a wireless communications network 100. In some embodiments, the communications network 100 comprises a Radio Access Network (RAN). It is commonplace today for communications to occur over a wireless network in which user equipment (UE) (such as, for example, UEs 101a, 101b, 101c, and 101d) connect to the network via a wireless transceiver, such an eNodeB (eNB), gNodeB (gNB), Access Point (or base station) 103, hereafter referred to generically as a BS/AP (base station/Access Point) or more simply, an Access Point (AP) 103. A wireless device operated by a user, commonly referred to as a “User Equipment” (UE), is typically in wireless communication with the Access Point (AP) 103, or, more specifically, via a base station antenna 130. Although only a single AP 103 is shown in FIG. 1, several APs 103 are used to communicate with a plurality of UEs in typical communication network 100 deployments.

As shown in FIG. 1, the BS/AP 103 (or a plurality of BS/APs 103 which are not shown in FIG. 1 for simplicity's sake) communicate with an Edge Node 120. The Edge Node 120 communicates with the other components of the RAN 100 and the RAN Core Network 114, and allows users of the various UEs 101 access to services provided by the RAN 100 including those provided by the Internet 107. In some embodiments, the RAN Core Network 114 comprises a 5G Core Network (5GC).

Throughout this disclosure, the term BS/AP is used broadly to include at least an eNB (Evolved Node B or E-UTRAN Node B) of a 4G network or gNB (5G node B) of an LTE/5G network, a cellular base station (BS), a Citizens Broadband Radio Service Device (CBSD), a WiFi access node, a Local Area Network (LAN) access point, a Wide Area Network (WAN) access point, etc. and should also be understood to include other network receiving hubs that provide wireless access to a network via a plurality of wireless transceivers. Note, also, throughout this disclosure, an eNB/gNB is also referred to herein as a BTS-CBSD. A CPE (described in more detail below) is also referred to in parts of the description of the present methods and apparatus as a CPE-CBSD.

A Radio Access Technology or (RAT) is the underlying physical connection method for a radio based communication network. Many UEs support several RATs in one device, such as Bluetooth, Wi-Fi, and GSM, UMTS, LTE or 5G NR. The current UEs prefer Wi-Fi over LTE. With enterprise deployments, the preference is to leverage LTE over Wi-Fi given the higher Quality of Service (QoS) offered by LTE networks. Additionally, the UE does not aggregate the traffic based on the type of application over LTE and Wi-Fi, even when the UE is associated with both an LTE and Wi-Fi network simultaneously. Such separation is supported only for Internet Packet Data Networks (PDN) versus IP Multimedia Subsystem (IMS) PDN connection across the two RATs and not within an Internet type application that are connected to a single PDN. While some solutions for using VPN connectivity to provide seamless connectivity exist, these are largely heavy weight and do not allow for make-before-break operation to minimize the transition times across the LTE and Wi-Fi networks.

FIG. 2 shows a block diagram of an exemplary embodiment of a fixed wireless network 200. The fixed wireless network 200 uses some components analogous to those shown in the wireless communication network of FIG. 1. Additionally, as shown in the fixed wireless network 200 of FIG. 2, the network 200 also is implemented using additional components such as CPEs (202, 204, and 206) and Wi-Fi networks and UEs capable of transmitting and receiving using both Wi-Fi and LTE wireless communications. The CPEs 202, 204, and 206 communicate on both the UL and DL with the CBSD_i using CBRS wireless communications. The UEs 101 communicate with the CPEs (e.g., CPE_i 202) via Wi-Fi communications. In some exemplary embodiments, a plurality of CB SDs 130 are used to communicate with the plurality of CPEs. As described in more detail below, the fixed wireless network 200 shown in FIG. 2 can advantageously be utilized to implement Wi-Fi and other functions in certain deployments.

Also, using specific information about the different components and performance/efficiency characteristics of the fixed wireless network 200, methods and apparatus for improved resource allocation in the fixed wireless network 200 can be implemented, resulting in an improved performance and efficiency of the fixed wireless network 200. In some embodiments, the information used by the disclosed methods and apparatus for resource allocation includes, but is not limited to the following: information about the various characteristics of the plurality of different Wi-Fi communications and networks; characteristics related to the CPEs; characteristics, limitations, and other information related to the UEs 101, the CPEs (202-206), and the CBSD (s) 130; the number of users attached thereto; the amount of spectrum available to be allocated to the CB SD (s) 130; a determination of achieved throughput on the DL from the CBSD (s) 130 to each of the CPEs connected thereto; a determination of achieved throughput on the UL from the CB SD (s) 130 to each of the CPEs connected thereto; and other factors and performance characteristics described below in more detail.

### BRIEF DESCRIPTION OF THE DRAWINGS

The disclosed methods and apparatus, in accordance with one or more various embodiments, is described with reference to the following figures. The drawings are provided for purposes of illustration only and merely depict examples of some embodiments of the disclosed methods and apparatus. These drawings are provided to facilitate the reader's understanding of the disclosed methods and apparatus. They should not be considered to limit the breadth, scope, or applicability of the claimed invention. It should be noted that for clarity and ease of illustration these drawings are not necessarily made to scale.

FIG. 1 shows an illustration of components of a wireless communications network.

FIG. 2 shows a block diagram of a fixed wireless network that may be used as a deployment of an Enterprise Network (EN); information derived from the Wi-Fi, CBRS, and LTE communications and characteristics of the EN, and its various components, are used by the present methods and apparatus to intelligently and efficiently allocate resources within the EN.

FIG. 3A is a block diagram of another exemplary embodiment of a wireless communications network showing wireless communications between a centralized SON block (located in the Core Network) and a plurality of BTS-CBSDs, wherein the plurality of BTS-CB SDs are in communication with a plurality of CPE-CBSDs, and wherein the resource allocation determination is performed by the centralized SON block.

FIG. 3B is a block diagram of another exemplary embodiment of a wireless communications network, wherein the wireless network of FIG. 3B is very similar to the wireless communications network of FIG. 3A, showing wireless communications between a centralized SON block (located in the Core Network) and a plurality of BTS-CBSDs, wherein the plurality of BTS-CBSDs are in communication with a plurality of CPE-CBSDs, and wherein the wireless communications network includes “external” Wi-Fi networks, communications, and a Wi-Fi controller block, wherein the Wi-Fi controller block is coupled to the SON block, and wherein the resource allocation determination is performed by the centralized SON block.

FIG. 4 shows a normalization function related to the present methods and apparatus for resource allocation in a fixed wireless network.

FIG. 5 shows a flowchart of one exemplary embodiment of a resource allocation method in accordance with the presently disclosed methods and apparatus for resource allocation in a fixed wireless network.

FIG. 6 shows a Sequence diagram between one or more CPEs, CBSD (s), and a SON device (a centralized entity device).

The figures are not intended to be exhaustive or to limit the claimed invention to the precise form disclosed. It should be understood that the disclosed methods and apparatus can be practiced with modification and alteration, and that the invention should be limited only by the claims and the equivalents thereof.

### DETAILED DESCRIPTION

The disclosed methods and apparatus for resource allocation in a fixed wireless network takes advantage of recent developments in wireless enterprise network deployments to enhance the experience in a fixed wireless network environment. Some of the novelty aspects of the methods and apparatus include but are not limited to the following:

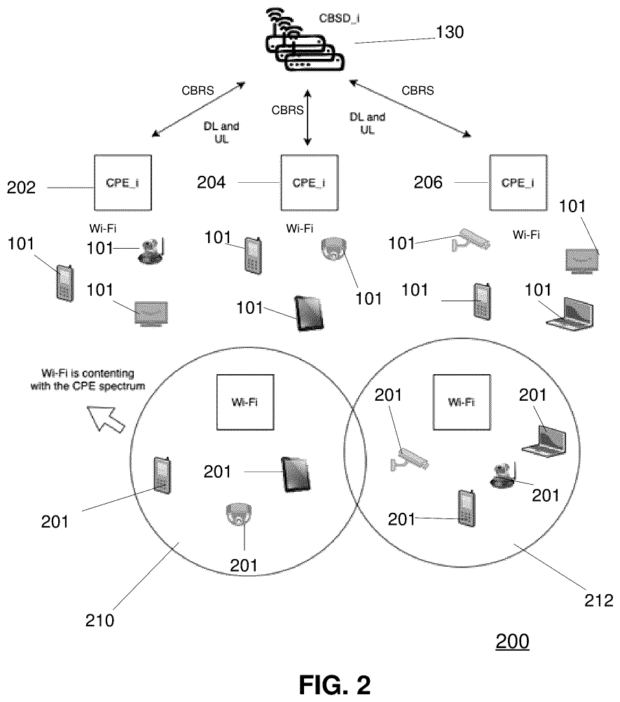

As noted in the brief description of the figures above, FIG. 2 shows a block diagram of a fixed wireless network 200 that may be used, in some embodiments, to deploy an Enterprise Network (EN). As briefly noted above, information derived from the Wi-Fi, CBRS, and LTE communications and characteristics of the EN 200 and its various components may be used to intelligently and efficiently allocate resources within the EN 200.

As shown in FIG. 2, the fixed wireless network (or EN) 200 comprises at least one CBSD_i 130, in wireless communication with a plurality of CPE_i s (such as, for example, the CPE_i s 202, 204 and 206). The CBRS spectrum is used for wireless communications, both on the downlink (DL) and the uplink (UL) between the one or more of the CPE_i s (such as, for example, the CPE_i 202, the CPE_i 204 and the CPE_i 206), and the one or more CBSD_i (s) 130. The fixed wireless network 200 may be used on in an enterprise campus, and/or in dense home apartment deployments. Such fixed wireless networks 200 may be utilized to implement, among other things, Wi-Fi communications and LTE communications to and from User Equipment (UEs 101) within the Enterprise Network (EN) and with an MNO. One application use for the CBRS spectrum is the fixed wireless scenario, wherein the EN 200 is deployed on an enterprise campus and dense home apartment environments. In such deployments, some of the User Equipment uses the network to gain Wi-Fi access. As described below in much more detail, information derived from the Wi-Fi communications, the UEs, the CPEs, and the CBSD(s) can be used to intelligently and efficiently allocate resources to devices and components within the EN 200, thereby improving network performance and efficiency.

As shown in FIG. 2, in some embodiments, the fixed wireless network 200 comprises one or more CBSDs 130 (which are also referred to herein as “BTS-CBSDs”), in communication with one or more CPEs such as CPE 202, 204 and 206. CBRS spectrum is used for communications between the CBSD 130 and the CPEs. Note that there could be just a few CPEs in one exemplary network deployment, while there may be hundreds in other exemplary network deployments.

In the EN 200 of FIG. 2, while the CBSD (s) 130 uses CBRS spectrum to communicate with the plurality of CPEs (on both the UL an DL), the CPEs communicate with a plurality of UEs 101 using Wi-Fi. Depending on loading conditions and traffic manifest at any selected CPE (e.g., the CPE 202), resource allocations might need to be adjusted to improve the performance and efficiency of the fixed wireless network 200. In addition to the Wi-Fi communications between the plurality of UEs 101 and their associated and connected CPE, it should be noted that various and different types of Wi-Fi communications (and networks) may exist within the EN 200 that are “external” to the Wi-Fi communications between the UEs 101 and their associated and connected CPE. Exemplary “external” Wi-Fi networks 210 and 212 are shown in FIG. 2. The presence of these external (external to the CBSD 130 and it's associated CPEs and their associated UEs), Wi-Fi communications can create interference problems within the EN 200 if not taken into account. Therefore, the present methods and apparatus for resource allocation in a fixed wireless network takes into consideration these “external” Wi-Fi communications that “contend” for the CPEs' Wi-Fi spectrum.

In some embodiments, all of the CBSDs 130 are deployed on a street pole pointing towards the CPEs (202, 204 and 206, for example) which are placed inside or outside of a building. These embodiments are helpful in visualizing the network 200 when it is deployed in dense apartment scenarios. The CPEs allow the UE devices, such as laptops, printers, TV, mobile phone, cameras, etc. to connect to the wireless network via the Wi-Fi spectrum. Consequently, the end-user experience is determined and based on BOTH the Wi-Fi spectrum allocation AND the CBRS spectrum allocation. In the wireless network of FIG. 2, it is assumed that there are more CPEs 202, etc., connected to the CBSD 130 via a wireless single-hop connection.

In a realistic or dense deployment environment, the Wi-Fi spectrum is not always guaranteed due to the fact that the Wi-Fi spectrum is unlicensed. Consequently, and as described in more detail below, the present methods and apparatus for resource allocation in a fixed wireless network takes into account the Wi-Fi contention nature variables (contention for the Wi-Fi spectrum) into the CBRS spectrum allocation for each CPE. Hence, overall spectrum and resource allocation at the CBSD 130 is maximized. For example, and as described in more detail below, the spectrum allocation is performed proportionally, based on the Wi-Fi contention, and the number of users connected to a CPE (e.g., the CPE 202). Both resource and CBRS/Wi-Fi spectrum allocation is important to model the end user performance. For example, if there is a greater number of connected users to a selected CPE, and if there is more Wi-Fi contention to that selected CPE, then the allocation of CBRS spectrum is increased for that selected CPE. In accordance with the present methods and apparatus for resource allocation in a fixed wireless network, the CBRS spectrum required is adjusted (to the extent possible) taking into account the impact of the Wi-Fi contention on the unlicensed spectrum.

Three important aspects are provided by the present methods and apparatus for resource allocation in a fixed wireless network such as the EN 200 of FIG. 2. A first important aspect relates to the fixed nature of the wireless network 200. The fixed nature of the CPE-CBSDs deployments creates a potential to allocate resources by optimizing the network in terms of beamforming, fractional frequency reuse (FFR), power control, etc. When this aspect is combined with the aspects described in the following two paragraphs, especially when it is combined with the aspect described in the next following paragraph, novel and nonobvious methods and apparatus for resource allocation in a fixed wireless network results.

A second important aspect of the fixed wireless network 200 is that the CBSD 130 (or BS/AP) measures the interference impact, offered load, throughput, and threshold to assess the demand or capacity. Combining these two important aspects together, the methods and apparatus for resource allocation in a fixed wireless network uses information obtained by these two aspects to assist in determining the following: (1) which UE attached to the CPE can be adequately served given the current resource allocation; (2) which fixed CPEs can be served in a certain manner given the current resource allocation; (3) can fractional frequency reuse (FFR) be performed; (4) can the methods or apparatus use/perform beamforming; (5) and can reuse of special diversity based mechanisms be used by which selected users are scheduled. The two important aspects described above provide the information necessary to assist in making these resource allocation determinations.

A third important aspect of the present methods and apparatus for resource allocation in a fixed wireless network is the option of using a centralized-based mechanism to execute the methods described herein. In some embodiments, this centralized device makes resource allocation decisions (and possibly makes changes to the EN 200 to implement these resource allocation decisions), wherein such resource allocation decisions improve the performance and efficiency of the EN 200. The centralized based decision approach accounts for all of the CPEs in the EN 200, CBSD (s) (such as CBSD 130), and neighboring networks (and possible interference to the EN communications caused by the neighboring networks), to assess the spectrum allocation at the CBSD 130 to service the CPE-CBSD wireless connections. The centralized based decision approach may also make appropriate requests of the SAS for appropriate bandwidth allocation.

Therefore, not only do the present methods and apparatus account for throughput information when making resource allocation decisions, they also account for loading information and all of the other conditions and characteristics of the EN 200 when making resource allocation determinations. The present methods of determining resource allocation in a fixed wireless network is, in some embodiments, made (or executed within) by a centralized component or location for resource allocation determination. After making this determination, the goal is to balance the spectrum allocation to the CB SDs (based on the knowledge of the traffic served by the eNodeB (CBSDs), the CPEs (how much bandwidth the CPEs need) and what the UEs demands are. Knowledge of the Wi-Fi characteristics allows the resources spectrum to be allocated efficiently and better assists in determining which resources/spectrum to allocate to other CBSDs that may comprise the wireless network (i.e., there can be one more CBSDs per EN network). Wi-Fi “contention” issues are also accounted for in the presently described methods and apparatus for resource allocation. As noted above, due to the unlicensed nature of the Wi-Fi spectrum, Wi-Fi interference or resource demands made by the various Wi-Fi devices and networks can occur within a single EN as shown in FIG. 2. Additionally, and possibly alternatively, Wi-Fi contention can be caused by a neighboring Wi-Fi network that is not part of the EN shown in FIG. 2, and it can also be caused by the MNO (larger wireless network). The same techniques and methods described herein can be used to effectively and efficiently allocate resources and spectrum in an MNO, a neighboring network, and within a single EN 200 as shown in FIG. 2.

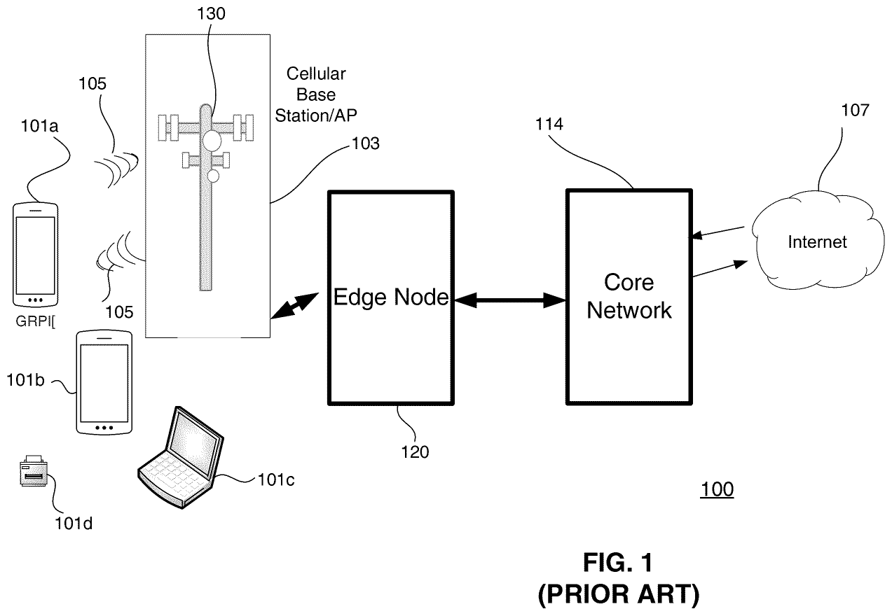

Therefore, the methods and apparatus for resource allocation in a fixed wireless network described herein are designed to address and solve several problems inherent in similar prior art networks. In accordance with the present methods and apparatus, an application or use of the components shown in the wireless network 100 of FIG. 1 and the fixed wireless network 200 of FIG. 2 is use of the CBRS spectrum for fixed wireless scenarios and applications, wherein enterprise campus and/or dense home apartment deployments of such fixed wireless networks may be utilized to implement, among other things, Wi-Fi communications. Disadvantageously, this use case may lead to potential problems in terms of resource allocation i.e., scheduling of radio resources, power control or link adaptation within the CBSD 130, and interference management from other MNOs if the deployments are nearby. One of the aspects of the presently described methods for resource allocation is the scheduling of radio resources within the CPEs (e.g., the CPE 202, 204 and 206) connected to one CBSD (s) (BS/AP) such as, for example, the CBSD 130 of FIG. 2. Note that the same methods and apparatus may alternatively, or in conjunction, be used for more than one CBSD 130. This is just one simple exemplary embodiment to help simplify the description and understanding of the present resource allocation methods and apparatus, and therefore does not limit the scope of the appended claims.

In some embodiments, the power control can be adopted by the scheduling of RBs. Also, in some embodiments, it is assumed for purposes of this disclosure that all of these devices are fixed CPE devices in the enterprise campus scenario. However, this assumption is for some embodiments of the present disclosed methods and apparatus. Other embodiments where this is not the case also fall within the scope of the appended claims.

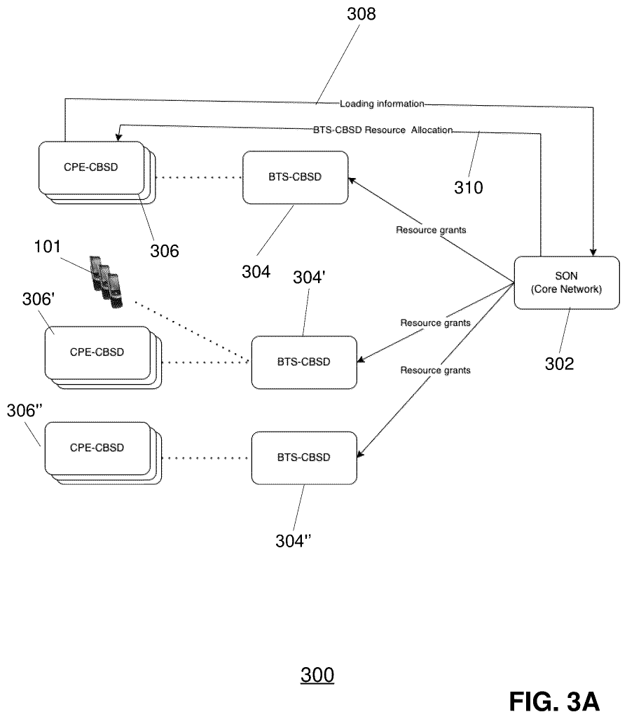

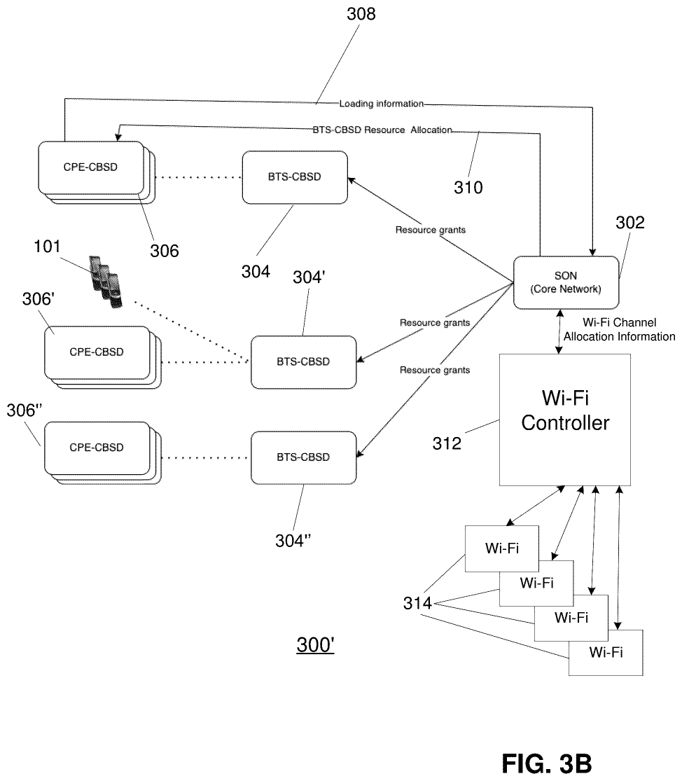

FIG. 3A is a block diagram of another exemplary embodiment of a wireless communications network 300 showing wireless communications between a centralized SON 302 device in a Core network and a plurality of BTS-CBSDs 304, 304′, and 304″, and wherein the plurality of BTS-CBSDs 304 (304′ and 304″) are in wireless communication with a plurality of CPE-CBSDs 306, 306′ and 306″, and wherein the presently described resource allocation methods are performed (executed) and determined by the centralized SON block 302. As shown in FIG. 3A, the CPE-CBSDs 306 transmit information, including loading information, along a communication path 308 from the various ENs 200 (see, FIG. 2 for example) back to the SON 302. Based upon the information provided by the plurality of CPE-CBSDs 306 to the SON 302, the SON allocates resources within the ENs 200 by issuing BTS-CBSD Resource Allocation information along a communication path 310 to the plurality of CPE-CBSDs 306. The SON 302 also communicates with the plurality of BTS-CBSDs 304 and issues resource grants to the BTS-CBSDs 304 when appropriate and depending on the availability of the resources that are requested at any given point in time.

As noted briefly above, FIG. 3B is a block diagram of another exemplary embodiment of a wireless communications network 300′, which network 300′ is very similar to the wireless communications network 300 of FIG. 3A. Similar to the wireless network 300 of FIG. 3A, the wireless network 300′ of FIG. 3B shows wireless communications between a centralized SON block 302 (located in the Core Network) and a plurality of BTS-CBSDs 304 (304′ and 304″), wherein the plurality of BTS-CBSDs 304 are in communication with a plurality of CPE-CBSDs 306 (306′ and 306″). The wireless network 300′ also includes a plurality of “external” Wi-Fi communications and external Wi-Fi networks 314. The plurality of external Wi-Fi networks communications and external Wi-Fi networks 314 communicate via Wi-Fi with a Wi-Fi Controller 312. The Wi-Fi Controller 312 communicates with the SON 302 via a bi-directional communication path. Wi-Fi Channel Allocation Information is exchanged between the SON 302 and the Wi-Fi Controller 312 the bi-directional communication path. The architecture of the fixed wireless network 300′ of FIG. 3B allows the resource allocation methods to account for Wi-Fi contention between the various “external” Wi-Fi networks (e.g., the external Wi-Fi networks 210, 212 of FIG. 2 and the Wi-Fi networks 314 of FIG. 3B) and the Wi-Fi traffic between the UEs 101 and the CPEs (202, 204, 206) (i.e., the CPE Wi-Fi spectrum). Cooperation between Wi-Fi and CBRS-CPE in channel assignment and operating frequencies (e.g., 2.4 GHz, GHz, and 6 GHz) within the deployment region leads to improvement in the wireless network performance an efficiency. The architecture of the wireless communications network 300′ of FIG. 3B, including the external Wi-Fi networks 314 and the Wi-Fi Controller 312, helps in implementing this cooperation.

It should be noted that the present methods and apparatus for resource allocation in a fixed wireless network can also be used to account for other technologies resulting in contention for CPE spectrum. For example, the present methods can consider contention caused by of other technologies such as Licensed Assisted Access (LAA) (4G LTE in Unlicensed) and New Radio Unlicensed (NR-U) (5G NR in Unlicensed), which technologies operate on the same unlicensed Wi-Fi spectrum band as the external Wi-Fi devices and networks. On many campuses, operators deploy LTE or NR in the unlicensed spectrum (similarly to the deployment of Wi-Fi unlicensed networks). Such an exemplary deployment is described in a document entitled “Hidden-nodes in coexisting LAA & Wi-Fi: a measurement study of real deployments”, written by Vanlin Sathya, Muhammad Iqbal Rochman, and Monisha Ghosh, published 31 Mar. 2021, and available on the World Wide Web (Internet) at https://arxiv.orgipd112103.15591.pdf; and this document is incorporated herein by reference as if set forth in full. As described in this incorporated document, LTE LAA in unlicensed is deployed in the Wi-Fi 5 GHz spectrum. The present methods advantageously consider spectrum contention caused by technologies other than that caused by unlicensed Wi-Fi communications and networks.

Note, there are various and different forms of Wi-Fi networks. All types of different Wi-Fi networks and Wi-Fi communications exist. The present methods and apparatus obtains the information regarding the Wi-Fi networks present in the ENs 200 that is necessary to incorporate into the resource allocation determinations. Note, that the presently disclosed methods and apparatus do not take into consideration “mobile Wi-Fi s” such as those implemented in some cell phones (UEs). Wi-Fi networks are unlicensed. Anybody can access the Wi-Fi networks. Therefore, assuming that a large number of Wi-Fi users operate on the same channel that a CPE 202 operates on, and even assuming that sufficient resources were previously allocated on the CBSD 130 side of the CPE 202, the resource allocation determination will be incorrect and insufficient unless the existing Wi-Fi network conditions are taken into account, and the resource allocation determination therefore will be insufficient to meet the demands of the Wi-Fi network users (UEs). Moreover, unless the Wi-Fi network conditions are accounted for in the resource allocation methods, the resource allocation determination will be insufficient to meet the demands of the UEs 101 in the wireless network 200.

To optimize the spectrum allocated to the plurality of BTS-CBSDs 304 by the SON 302, and the resources allocated to the plurality of components within each of the plurality of ENs 200, the SON 302 inputs a significant amount of information that characterizes the performance of the plurality of ENs 200 and corresponding components therein. In some embodiments, this information includes (but is not limited to) the following: (1) the amount or degree of contention for Wi-Fi resources between external Wi-Fi devices and networks and Wi-Fi communications within each EN 200; (2) the number of users attempting to access the EN network 200 through its associated and corresponding selected BTS-CBSD using each of a plurality of CPE-CBSDs within each EN 200; (3) a number of CPE-CBSDs that are attempting to provide access to their associated and corresponding selected BTS-CBSD for the plurality of UEs in the EN 200; (4) an amount of spectrum available to be allocated to the selected BTS-CBSD by the SAS/SON; (5) the achieved throughput on a downlink (DL) from the selected BTS-CBSD to each of the plurality of CPE-CBSDs connected to the selected BTS-CBSD; the achieved throughput on a uplink (UL) from the plurality of CPE-CBSDs to the selected connected BTS-CBSD; and (6) the achieved latency between the selected BTS-CBSD and each of the plurality of CPE-CBSDs connected to the selected B TS-CB SD.

As shown in the fixed wireless network 300′ of FIG. 3B, in some embodiments, Wi-Fi channel allocation information is exchanged between the Wi-Fi Controller 312 and the SON 302. In these embodiments, Wi-Fi Network Information is monitored by the Wi-Fi Controller 312. The Wi-Fi Controller 312 monitor conditions in the Wi-Fi network, and provides Wi-Fi related information to the SON 302 or centralized device, so that the SON 302 can more accurately and efficiently allocate resources thus improving the overall wireless network performance. The CBSD (s) 130 and CPEs (202, 204, and 206) use this information (or “feedback”) regarding the Wi-Fi network so that it can allocate resources in such a way as to enable it to control the resource allocation more efficiently. Feedback/information about the external Wi-Fi networks is input to the selected CBSD 130 (see, e.g., FIG. 2) or central controller SON 302 (see, FIGS. 3A and 3B) to assist in dynamically controlling recourse allocation, including network control of all types of resource allocation, including but not limited to beamforming, changing of the TDD allocations, performing power control, changing the DL and UL demand, etc.

As shown in the wireless networks 200 (of FIGS. 2) and 300, 300′ (of FIGS. 3A and 3B, respectively), the execution of the presently disclosed methods and apparatus for resource allocation in a fixed wireless network can be implemented within a selected CBSD 130 of the fixed wireless network 200, or, optionally, it may be implemented in a centralized (possibly external to the EN 200 of FIG. 2) device, and not in the CBSD 130. Examples of such centralized resource allocation decision making an implementation are shown in the wireless networks 300 and 300′ of FIGS. 3A and 3B, respectively, wherein the resource allocation methods are executed by a centralized SON 302 device.

No matter how the fixed wireless network is implemented, the present methods and apparatus for resource allocation in a fixed wireless network improves resource allocation for the EN CBSDs 130 (or BTS-CBSDs 304) when compared to the prior art resource allocation techniques. The present resource allocation is based on many factors (enumerated above), and is, importantly, based on end user device characteristics, the performance of upward load requirements, and the CPE upward load requirements.

Note that the term “resource” or “resources” can refer to almost every component and aspect of wireless communications networks. In essence, almost everything in a wireless communications network comprises a resource. For example, a PRB comprises a resource. Power and power transmission comprises a resource. Communication transmission channels may be considered resources. TDD configurations may also be considered as network resources, etc. Therefore, subject to the limitations of the CBSD 130, the present methods and apparatus for resource allocation in a fixed wireless network perform resource allocation determinations that maximize the performance and efficiency of the EN 200 of FIG. 2 and the wireless networks 300 and 300′ of FIGS. 3A and 3B, respectively. The resource allocation determinations also maximize the performance and efficiency of the CBSDs 130 within the EN 200. Importantly, these resource allocation determinations are not made based upon monitoring traffic at the CBSD 130 (FIG. 2) or the eNodeB, but rather they are made by monitoring the traffic at the CPEs (202, 204, 206), and possibly the end user devices UEs 101 affecting the behavior of the CBSD (s) 130. Measurement are made at the CPEs, reported to the cloud or some centralized device, resource allocation determinations are made in the cloud or by the centralized device (such as the SON 302 of FIGS. 3A, 3B), and the appropriate resource allocation adjustments are made to the ENs 200 and their associated and corresponding CB SDs 130 accordingly.

The communications (via Wi-Fi) between the CPEs and the UEs provide a better measurement for resource allocation determination than does simply monitoring traffic occurring at the CBSDs 130. Improved visibility is achieved by monitoring communications beyond the CBSDs 130 (i.e., at the CPEs (202, 204, 206), and improved visibility is also achieved by monitoring activity behind the CPEs (that is, by monitoring the Wi-Fi communications and characterizations of the external Wi-Fi networks 210, 212 and the Wi-Fi communications beyond the CPEs 202, 204, and 206. This information regarding the Wi-Fi traffic and communications occurring beyond the CBSD 130 is used to better qualify and determine the optimal resource allocation. By monitoring the Wi-Fi traffic between the CPEs 202-206 and the UEs 101, and by also monitoring Wi-Fi contention with the CPE spectrum caused by external Wi-Fi networks and Wi-Fi communications, a more improved and accurate resource allocation can be determined and implemented. This method provides a much improved technique of allocating resources in a fixed wireless network as compared to the prior art approaches. In addition, in some embodiments, the present methods and apparatus for resource allocation in a fixed wireless network coordinates activities between different CPEs (for example, between the CPE 202 and the CPE 204) to better determine how to allocate network resources within the ENs.

Note, also, in some embodiments, the UEs 101 can communicate directly with the CBSD (s) 130 via LTE communications. This also needs to be accounted for in the present methods and apparatus and determination of network resource allocation. The UEs 101 may simply comprise another LTE connection to the CBSD 130, and is therefore also taken into consideration when resource allocations are determined.

### Resource Allocation

In some scenarios, it is assumed that there are three or more CPEs connected to a CBSD (e.g., the CBSD 130 of FIG. 2) via a wireless single-hop connection. In some embodiments, all of the CBSDs are deployed on a street pole pointing towards the CPEs which are placed inside or outside of the building. Such deployments are easy to visualize in the apartment deployment scenarios. We assume that all of the CBSDs are CAT B, small cells, deployed outdoors. These CPEs allow devices such as laptops, printers, TV, mobile phone, cameras, etc. to connect via the Wi-Fi spectrum. Hence, the end-user experience is based on both spectrum allocation i.e., Wi-Fi spectrum+CBRS spectrum. In a realistic or dense environment, the Wi-Fi spectrum is not always guaranteed due to the nature of unlicensed spectrum. So, the contention nature variables are considered into the CBRS spectrum allocation for each CPE. Hence, overall spectrum allocation at the CBSD is maximized. All the CPE-based Wi-Fi channel allocation occurs on the centralized controller to choose the least contended (or least contention) channel as much as possible in the 2.4, 5 and 6 GHz spectrum.

### Spectrum Allocation Method 1 for each CBSD Within an MNO

In this scenario, a selected CPE that operates on the Wi-Fi CSMA protocol needs to access the unlicensed medium. Hence, there is contention and collision depending upon the load on the Wi-Fi channel. Therefore, contention in a selected CPE device is taken into consideration by the spectrum allocation Method 1. So too is the extent of occupancy of the MAC. In accordance with the present methods and apparatus for resource allocation in a fixed wireless network, the scheduling of RBs are modeled in the CBRS spectrum by considering this Wi-Fi contention. The Wi-Fi contention, C_i, is dependent upon the number of Wi-Fi APs deployed on the same channel and the number of STAs connected to the APs which lead to more contention on the data, control, and management frames.

The spectrum allocation is performed proportionally based on the Wi-Fi contention and the number of users connected to the selected CPE. Both allocation factors are important to model the end user performance. If there is a greater number of connected users to the selected CPE, and if there is more contention to the selected CPE, then allocation of CBRS spectrum will be increased to the selected CPE.

Table 1 shows inputs to the resource allocation algorithm when allocating spectrum for each CBSD within an MNO (i.e., “Method 1”):

TABLE 1
INPUTS TO SPECTRUM ALLOCATION METHOD 1

| Notation | Abbreviation |
|---|---|
| Cᵢ | Contention at the ith CPE box |
| Uᵢ | Number of users in the ith CPE box of both UL and DL |
| B | Number of CPE boxes-set of all CPE boxes in this particular EN |
| | deployment |
| S | Total available spectrum per CBSD based on SAS/SON |
| Uᵢ^{DL} | Achieved Throughput in DL |
| Uᵢ^{UL} | Achieved Throughput in UL |
| Uᵢ^{L} | Achieved Latency in DL and UL |

Primarily, this Method 1 assesses the usage on the upward load and the implications of the conditions as manifested in the CPEs. This is one of the important goals of the disclosed method for resource allocation within a fixed wireless network. This implies that whatever information can be gleaned from the CPEs are relevant to the resource allocation method. Two factors should be taken into consideration when allocating resources in a fixed wireless communication network: (1) contention alone (contention with the external Wi-Fi networks and Wi-Fi communications) does not determine the behavior of the CPEs for the simple reason that the contention might be caused by traffic for a local environment. The CPEs might be serving local UEs that are located directly proximate the CPEs the majority of the time. (2) The throughput required on both the downlink (DL) and the uplink (UL) radio channels between the CPEs and their associated and connected CB SD (s) must also be accounted for and taken into consideration by the resource allocation method. Contention alone does not provide sufficient information to make the correct resource allocation determination. Contention does not implicitly relate to all LTE traffic. The present method takes both contention and throughput (between the CPEs and their associated CBSD) into account when making resource allocation determinations. The present Method 1 can be used in both 4G and 5G RAT networks.

It should be noted that in a dense Wi-Fi AP deployment scenario, 60 to 70% medium will be occupied with the control and management frames and only — 30 to 40% of the medium will have reliable data transmission.

### Spectrum Allocation Method 1—An Exemplary Algorithm

An exemplary spectrum allocation method 1 algorithm is set forth below, given the inputs set forth above in Table 1:

### Method 1 Algorithm

For i in CPE B,

$${S}_{-} i = ( {S}^{*} ( C \_ i + U \_ i ) ) / for all j ( C \_ j + U \_ j )$$

$${S}_{i} = \frac{S * ( {C}_{i} + {U}_{i} )}{{\sum }_{j} {C}_{j} + {U}_{j}} .$$

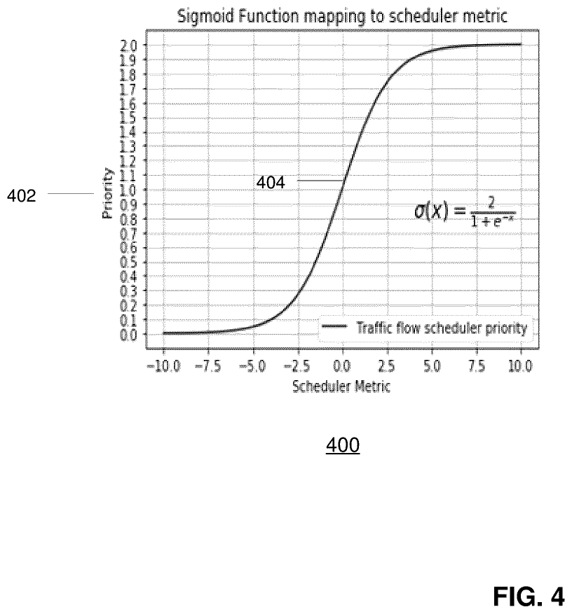

C_i and U_i are normalized to lie between 0 and 2. This normalization of these inputs is shown in FIG. 4.

After the resource allocation based on S_i is performed, it is important to check the achievable throughput on the DL and the UL to the connected CPE based on the configured TDD pattern.

$$Achieved Throughput in DL ( {U}_{i}^{DL} ) = DL Avg ( \frac{{T}_{n {B}_{i}}}{{T}_{t}} ) ;$$

$$Achieved Throughput in UL ( {U}_{i}^{UL} ) = UL Avg ( \frac{{T}_{n {B}_{i}}}{{T}_{t}} ) ;$$

Where, T_{nB}_{ᵢ} represents the number of bits transmitted over the air at total time Tt.

If the achieved throughput is not beyond the threshold, then tune the power in the RB allocation, enable fractional frequency reuse (FFR), and beamforming in the possible location based on the neighboring or co-channel interference. Adjust the TDD configuration of the individual CBSDs to adapt to the DL and UL demands of the individual CPE-CBSDs; adapt the power levels of the CBSD and CPE-CBSD based on the proximity to each other to enable a larger overall system capacity across the CBSDs; support beamforming techniques for a beam focused interaction between CB SDs and CPE-CBSD; and accommodate FFR when possible to enable overall capacity of the network. The exemplary algorithm also includes the steps of Managing the changes to bandwidth, TDD configuration, power, beamforming, FFR techniques of the CBSDs to ensure stabilization of the network before including further changes.

When a clear determination of the demands of the CPE-CBSD cannot be obtained, or when the demand for all the CPE-CBSDs is measured to be too high, the algorithm includes allocating equal bandwidth to the CB SDs servicing the different CPE-CBSDs.

Similarly, if the latency of the connected users to the CPE is high in the DL or the UL, after the proportional split allocation of the spectrum S_i in the network, then the SON or the CB SD algorithm will adjust the TDD configuration, power, and/or FFR accordingly.

Achieved Latency in the DL (Uᵢ^{L})>Th; and

Achieved Latency in the UL (Uᵢ^{L})>Th.

### Output (“Answers”) Generated by the Spectrum Allocation Method 1

Ultimately, the algorithm set forth above for the resource allocation Method 1 determines the number of resource blocks that are assigned by the CB SD (s) to each selected CPE_i. Therefore, S_i (in the algorithm set forth above) represents the resource blocks assigned by the CBSD (s) to each selected CPE_i. S_i is the CBRS spectrum, however, the resource allocation is performed while also considering the impact of the Wi-Fi contention on the unlicensed spectrum.

### Normalization Function

A normalization function 400 related to the methods and apparatus for resource allocation in a fixed wireless network is shown in FIG. 4. A Sigmoid Function mapping to scheduler metrics (which scheduler metrics are set forth on the x-axis of the plot 400) is shown in FIG. 4 resulting in the curve 404 shown in FIG. 4.

“Priority” values 402, as shown along the y-axis of the function 400, comprises weighting values or “weights”. As noted in Method 1 above, for example, C_i and U_i are normalized to lie between 0.0 and 2.0, wherein C_i comprises the contention at the ith CPE device, and U_i comprises the number of users in the ith CPE device of both the UL and the DL. The normalization function 400 uses a model weighting of the input values. The Sigmoid curve 400 will then vary accordingly. Weight determination is derived from the priority number. Each factor is weighted by its importance/priority to the resource allocation method. Different functions/factors/resource allocations (e.g., PDBs [packet delay budgets] delivery (which must be delivered in 300 ms. or less), jitter, latency, throughput, etc.) are assigned different priorities (i.e., different “weights”). Several different weightings can be used. As described above, several different factors are used in the present resource allocation algorithm, and some factors are more important than others and therefore are given more weight (i.e., are assigned higher or lower priorities as shown in the normalization function 400 (and along the y-axis 402) of FIG. 4.

Resources are not allocated directly to the CPEs based on the determinations made by the present resource allocation algorithms. Rather, the present resource allocation algorithms determine how to allocate resources to a eNodeB/gNodeB (i.e., the CBSDs 130). This assists in addressing and solving the resource allocation issues for the CPEs (202, 204, 206). One important goal is to plan the deployment of a fixed wireless network comprising an Enterprise Network (EN) such as the EN 200 of FIG. 2. One means of accomplishing this goal is to allocate resources to the appropriate eNodeB/gNodeB (CBSD 130 as shown in FIG. 2). The more resources are allocated (increases in resource allocation) and provided to a selected eNodeB/gNodeB (CBSD 130), the more resource allocation is also provided to the CPEs that are associated with and connected to the selected eNodeB/gNodeB (CBSD 130).

The metrics used for prioritization are based on filtered values. The filter constants can be adjust based on the individual metric. Exponential filter should be sufficient.
For pdb=packet delay in the scheduler.
For GBR=R_avg−R_gbr
For nonGBR/BE=R inst_R_avg−R_gbr; removing non-opportunistic traffic from the computation. All priority computed in the range of [0, 2]=[low, high].

A higher computed metric results in a value closer to 2. As more resources are granted to the traffic-flow/UE, it is less likely to get more resources in the future. This makes the behavior implicitly non-linear. The steepness of the curve 404 can be adjusted based on the metric. This controls the aggressiveness of the throttling. This also allows for normalizing all scheduler metrics (set forth along the x-axis of the plot 400 shown in FIG. 4) on a single scale.

### Spectrum Allocation Method 2 with Neighboring MNOs

In this scenario, if other MNOs operate nearby or proximate the fixed wireless network,

with the same GAA channels on the same TDD configuration, or on different TDD configurations, then the interference and allocation of spectrum will vary based on the SAS/SON (302). Consequently, the algorithm of Method 1 set forth above can be used in these scenarios, however only the Spectrum set “S” varies based on the resource allocation.

S=Co-channel Interference_CBSD_MNO_i+TDD DL and UL slot impact_MNO_i.

Based on the co-channel interference and TDD DL and UL slot impact. The resource

allocation is split proportionally based on the algorithm as shown below:

### Spectrum Allocation Method 2—Another Exemplary Algorithm

An exemplary spectrum allocation method 2 algorithm is set forth below, given the inputs set forth above in Table 1:

### Method 2 Algorithm

For i in CPE B,

$${S}_{-} i = ( {S}^{*} ( C \_ i + U \_ i ) ) / for all j ( C \_ j + U \_ j )$$

$${S}_{i} = \frac{S * ( {C}_{i} + {U}_{i} )}{{\sum }_{j} {C}_{j} + {U}_{j}}$$

After the resource allocation based on S_i, it is important to check the achievable throughput on DL and UL to the connected CPE based on the configured TDD pattern.

$$Achieved Throughput in DL ( {U}_{i}^{DL} ) = DL Avg ( \frac{{T}_{n {B}_{i}}}{{T}_{t}} ) ;$$

$$Achieved Throughput in UL ( {U}_{i}^{UL} ) = UL Avg ( \frac{{T}_{n {B}_{i}}}{{T}_{t}} ) ;$$

Where, T_{nB}_{ᵢ} represents the number of bits transmitted over the air at total time Tt.

If the achieved throughput is not beyond the threshold, then tune the power in the RB allocation, enable fractional frequency reuse (FFR), and beamforming in the possible location based on the neighboring or co-channel interference. Similarly, if the latency of the connected users to the CPE is high in DL or UL after the proportional split allocation of the spectrum S_i in the network, the SON 302, or the exemplary CBSD algorithm, can adjust the TDD configuration, power, FFR, etc., accordingly.

Achieved Latency in DL (Uᵢ^{L})>Th; and

Achieved Latency in UL (Uᵢ^{L})>Th.

### Spectrum Allocation Method 3—Another Exemplary Algorithm

An exemplary spectrum allocation method 3 algorithm is set forth below, given the inputs

set forth above in Table 1:

### Method 3 Algorithm

In accordance with this method 3 algorithm, the total number of the spectrum to all CPEs are equally divided without considering proportional fairness to the system. Other additional information on the CPE and the CBSD that is useful when performing accurate and efficient resource allocation in a fixed wireless network is set forth below:

### Account for Information That Can Be Determined From the BTS-CBSD and Collect Metrics on How Individual CPEs are Being Served

The information that can be collected at the CPE are:
The achievable throughput or aggregate DL, throughput at the CPE in each tit time;
The latency of the connected STAs for real-time and non-real-time traffic;
Jitter performance on the real-time traffic, when there is a mixed nature of applications such as DL, LTL, DL+UL, Ping, etc.; and
The transmission opportunity time for the CPE to access the unlicensed channel.

Congestion is determined at the CPE as follows:
Assuming there is sufficient bandwidth at the CBSD to CPE connection:
Based on the buffer queue size processing at the CPE;
The number of QoS packets crossed the deadline in transmission;
Increase the number of delays to the connected STAs to CBSD; and
Experience more packets dropped due to buffer overflow.

The information (raw/processed) that needs to be shared from the CPE-CBSD 130 to the central resource allocation planning entity (e.g., the SON 302) is the following:
Number of devices connected to CPE;
Demand or expected throughput in the CPE system;
Channel access or transmission opportunity at CPE for real-time and non-real-time traffic;
Transmission power: High, Medium, and Low, and operating frequency: 2.4, 5, or 6 GHz;
Operating bandwidth: 20, 40 or 80 MHz;
Operating Channel: UNIT-1, DFS (UNH-2) and UNII-3;
Operating mode: 802.11 a/b/g/n/ac/ax;
Number of Wi-Fi APs nearby (based on RSSI) deployed on the same exact channel;
Number of Wi-Fi APs nearby (based on RSSI) deployed on the overlapping channel in terms of primary and secondary; and
Identify the active APs based on management, control, and data frames and non-active APs based on only beacon transmission.

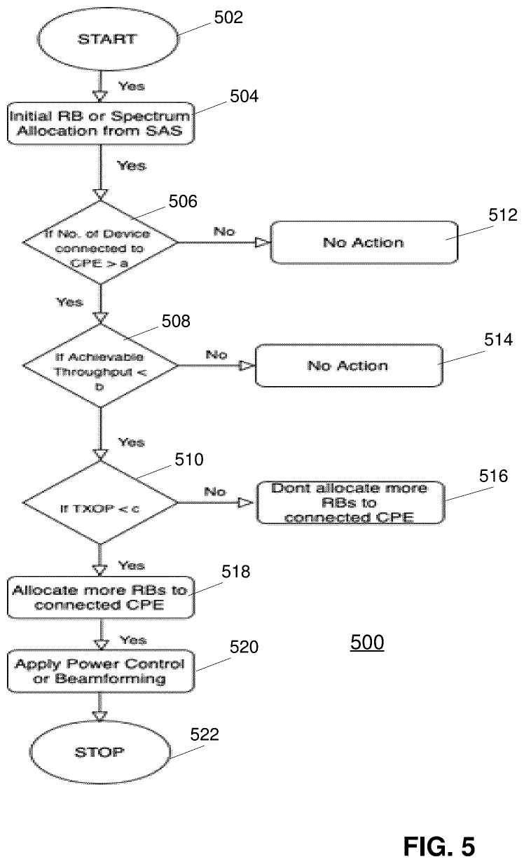

FIG. 5 shows a flowchart of one exemplary embodiment of a resource allocation method in accordance with the presently disclosed methods and apparatus for resource allocation in a fixed wireless network. The exemplary method 500 determines resource block (RB) allocation to be provided to each CPE (e.g., CPE 202, 204, and 206) in the fixed wireless network. The method 500 can be extended for use in allocating resources to multiple CPEs.

The method 500 takes the number of users into account, and number of CBSDs into account, and what is achievable given a selected threshold in order to achieve the desired results. As described in more detail below, the method 500 also considers the “transmission opportunity” “TXOP” value (at a block 510). What this means is, if Wi-Fi is operating at the CPE as a Wi-Fi network, the CPE keeps frequently obtaining the Wi-Fi channels. That means no other Wi-Fi channels are nearby the selected CPE. Consequently, there is no point for contention in this scenario.

The method 500 starts at the block 502. It proceeds to a block 504 where an initial RB or Spectrum Allocation is obtained from the SAS. In fact, the SAS portion comes after the SON 302. Often the SAS is not even utilized. The method then moves on to a block 506 whereat the selected CPE provides or informs the resource allocation determination mechanism (the SON 302, for example) the number of user devices (UEs) that are connected to the selected CPE. At a block 508, the selected CPE also provides information regarding the achievable throughput in the UL and DL between the CPE and the UEs connected to it. This is helpful information to determine what the resources the selected CPE needs in order to meet the demands of the UEs that are connected to it.

The CPE (202, 204, 206) sends the requirements it needs to the CBSD 130, much like the UEs do. As briefly noted above, at a block 510 the method 500 determines if “TXOP” is less than “c”. TXOP means “transmission opportunity”. If the selected CPE has relatively good transmit opportunities (TXOP is less than a threshold “c”) (because, for example, these transmit opportunities are not being occupied or required by Wi-Fi transmissions), but the selected CPE is still experiencing difficulties obtaining enough resources to meet the UE/CBSD demands, then the selected CPE is given more resources (RBs) at the block 518. If the Wi-Fi CPE obtains the Wi-Fi channels quickly, and it keeps on increasingly obtains more and more Wi-Fi channels, there is no real contention occurring at the selected CPE.

If TXOP remains less than the threshold, “c”, then more RBs are allocated to the connected selected CPE at the block 518. However, as the value of TXOP increases, that means there are more Wi-Fi networks and more Wi-Fi communications occurring, there are less transmit opportunities available to the selected CPE, and the CPE provides this information to the CBSD 130. The CBSD 130 then uses this information to determine if it needs to allocate more or less resources to this selected CPE based on the information provided by the selected CPE. If TXOP increases beyond the threshold “c” at the block 510, then the method moves to the block 516 and does not allocate more RBs (Resource Blocks) to the connected selected CPE.

This is because if there are nearby Wi-Fi networks, it is not necessarily required to allocate more RBs to the selected CPE at the block 518. Rather, good results can be achieved by adjusting the power control, and/or adjusting the beamforming, and/or changing the channel band at the block 520. Performing resource allocation in this manner reduces interference to the neighboring networks. However, the resource allocation method can only take advantage of this approach when the demand is low.

Referring again to the method 500 of FIG. 5, no action is taken in a block 512 if the number of devices connected to the selected CPE is greater than a threshold “a”. As described above, if the number of devices connected to the selected CPE is less than the threshold “a”, the method moves to the block 508. Similarly, if at the block 508 it is determined that the achievable throughput is less than a threshold “b”, the method moves to a block 514 whereat no action is taken. The method stops at a block 522 as shown in the method 500 of FIG. 5.

Based on system loading, information is provided from a central entity (for example, provided by the SON 302) to the selected CPE-CBSDs to have them throttle the users/applications running on the selected CPE. Said in other words, back pressure from the 4G/5G network is provided to regulate the operable conditions of the selected CPEs. Based upon the availability of the spectrum at the SAS and nearby interference, the selected CBSD needs to instruct or throttle the selected CPE based upon the nature of applications or number of users that need service at a given time of operation. As described above, and as described in more detail below with regard to the Power Control aspects of the present methods and apparatus for resource allocation, the amount of spectrum may also be dependent on beamforming, power control, reuse of spectrum mechanisms such as FFR, and other factors described above.

### Power Control/Power Management

Changing the Tx (transmit) power of the cell impacts the footprint and coverage of the cells. When the BTS-CBSD is able to determine the location of the UEs and CPEs associated with itself, the BTS-CBSD can pull back from the supportable maximum Tx power while still accommodating the devices associated with the cell. This change of power impacts the HO procedures and the thresholds for hand-in based on the measurement reports from the UEs operating in the neighboring cells and needs to be adjusted appropriately. Once the handover request is received in the given BTS-CBSD, the Tx power is adjusted to accommodate the incoming UE based on its determined location. This Tx power adjustment is constantly adapted based on the locations of the devices associated with that BTS-CBSD.

The prior art resource allocation techniques do not use power control in this manner. As noted above, changes in power control translates to change in the cell footprint. So, if the number of UEs and CPEs serviced by the CBSD (s) within the EN is known, it is possible to take advantage of this and transmit only so much power that is necessary to adequately service them and meet their demands. This power control or power management can be performed without causing any issues with the footprint of the EN 200. Reducing the footprint does not impact our performance because the number of UEs and CPEs in the EN is known.

### Sequence Diagram Showing Flow Sequences Between the Plurality of CPEs, the CBSD and the SON (Centralized Entity)

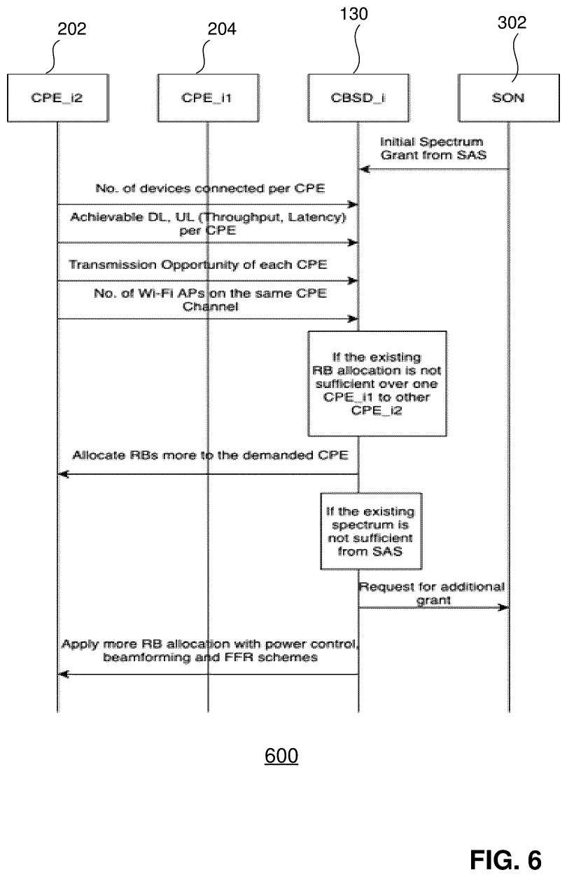

FIG. 6 shows a Sequence diagram 600 between one or more CPEs 202, 204, for example, CB SD (s) (130, for example), and a centralized SON device 302 (a centralized entity device). First the CBSD 130 must be initialized and operable, and this allows the CPE to permit Wi-Fi communications to occur. Once Wi-Fi communications occur, the CPEs are able to determine how many user devices (UEs 101) are connected to each CPE. The achievable DL and UL (throughput and latency per CPE) also becomes known to the CPEs. Transmission Opportunities for each CPE is provided as input to the CBSD. The number of Wi-Fi transmissions (APs) operating on the same channel as the CPE Wi-Fi channel is also evident, and this information is provided as input to the CBSD 130. Once this input information is obtained, the resource allocation methods and apparatus can then decide, based on all this information, whether resource allocation is necessary, and if so, the best way to perform the resource allocation.

The sequence diagram 600 of FIG. 6 simply shows how all the inputs are provided to the CBSD 130 so that it can make the proper resource allocation decisions. Note, in some exemplary embodiments, the CBSD 130 makes the resource allocation decisions. In some other embodiments of the present methods and apparatus, a centralized device external from the EN, such as, for example, the SON 302, makes the resource allocation decisions. For example, in some embodiments, the CPEs 202, 204 communicate their input information directly to the SON 302, and not to the CBSD 130 as shown in the sequence diagram 600 of FIG. 6. The SON 302 could also, in some embodiments, control the CPEs directly and not control them via the CBSD 130 as shown in FIG. 6. The CPEs 202, 204 are aware of their limitations (such as the spectrum allocated to them), so each CPE can provide this information to the central resource allocation algorithm. The CPEs can, in some embodiments, use the knowledge about their limitations to “throttle back” (or reduce the demands made by) the UEs that are connected to them. Note, that even if the CPEs demand more resources, the CB SD 130 has certain limitations. The CB SD 130 therefore can only deliver the resources to the CPEs if the demand does not exceed the CBSD resource limitations. If necessary, as a result of the CBSD's limitations, the CPEs will throttle back the throughput to the UEs connected to the CPEs.

### CONCLUSION

Methods and apparatus for resource allocation in a fixed wireless network have been described. In some embodiments the fixed wireless network is deployed as an Enterprise Network. In some embodiments, resources are allocated to the fixed wireless EN by a centralized and external (external to the EN) SAS/SON. The resources are allocated to a BTS-CBSD (or CBSD in some embodiments) based on the following input information: (1) the conditions of a Wi-Fi connection between the BTS-CBSD (or CBSD) and each of a plurality of CPE-CBSDs (or each of a plurality of CPEs in some embodiments); (2) the number of users being serviced by each CPE-CBSD (or by each CPE); (3) the contention for the Wi-Fi channels at each CPE-CBSD (or at each CPE); (4) the total amount of spectrum available to be allocated to the BTS-CBSD (or CBSD) by the SAS/SON; (5) the achieved downlink (DL) throughput between the BTS-CBSD (or CBSD) and the CPE-CBSD (or CPE); (6) the achieved uplink (UL) throughput between the BTS-CBSD (or the CBSD) and the CPE-CBSD (or the CPE); and (7) the achieved latency between the BTS-CBSD (or the CBSD) and the CPE-CBSD (or the CPE). By using these metrics, the throughput of the Wi-Fi connection between the plurality of CPE-CBSDs (or CPEs) and the UEs can be effectively matched to the amount of resources allocated to each CPE-CBSD (or to each CPE) and to the total amount of resources allocated to the BTS-CBSD (or allocated to the CBSD in some embodiments). 8) Based on the resources allocated to the BTS-CBSD (or the CBSD), the supportable users/flows at the CPE-CBSDs (CPEs) are regulated.

### Some Novel Aspects and characteristics of the present methods and apparatus for Resource Allocation in a Fixed Wireless Network

Some novel aspects and characteristics of the present methods and apparatus for resource allocation in a fixed wireless network are set forth below for convenience:

Importantly, the fixed nature of the CPE-CBSDs deployments creates a potential to allocate resources by optimizing the network in terms of beamforming, fractional frequency reuse (FFR), power control, etc. In addition, the CBSD 130 (or BS/AP) measures the interference impact, offered load, throughput, and threshold to assess the demand or capacity. Also, a centralized-based resource decision approach may be used in some embodiments to make the resource allocation determinations and implement the determined resource allocation accordingly in the wireless network. The centralized based decision approach accounts for all of the CPEs in the EN 200, CBSD (s), and neighboring networks (and possible interference to the EN communications caused by the neighboring networks), to assess the spectrum allocation at the CBSD to service the CPE-CBSD wireless connections. The centralized based decision approach may also make appropriate requests of the SAS for appropriate bandwidth allocation.

Other novel aspects and characteristics of the present methods and apparatus for resource allocation in a fixed wireless network include the following: (a) providing dynamic bandwidth allocation based on changes in the demand profile of CBSDs (BS/APs); (b) an ability to adapt the neighboring network operations on a co-channel and resolving to use the appropriate TDD configuration to avoid the interference with the neighboring networks and determine the bandwidth allocation requirements taking the TDD configuration into consideration; (c) adjusting the TDD configuration of the individual CB SDs to adapt to the DL and UL demands of the individual CPE-CBSDs; (d) a capability to adapt power levels of the CB SD and CPE-CBSD based on the proximity to each other to enable a larger overall system capacity across all of the CBSDs (BS/APs) in the fixed wireless network; (e) supporting beamforming techniques for a beam focused interaction between CBSDs and CPE-CBSDs; (f) accommodating FFR when possible, to enable the overall capacity of the network; (g) managing the changes to bandwidth, TDD configuration, power, beamforming, and FFR techniques of the CBSDs to ensure stabilization of the wireless network before including further changes; and (h) when a clear determination of demands of the CPE-CBSD cannot be performed adequately, or when the demand for all of the CPE-CBSDs is measured to be high, allocating equal bandwidth to the CB SDs servicing the different CPE-CBSDs.

Although the disclosed methods and apparatus is described above in terms of various examples of embodiments and implementations, it should be understood that the particular features, aspects and functionality described in one or more of the individual embodiments are not limited in their applicability to the particular embodiment with which they are described. Thus, the breadth and scope of the claimed invention should not be limited by any of the examples provided in describing the above disclosed embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide examples of instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosed methods and apparatus may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described with the aid of block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. An apparatus for resource allocation within a fixed wireless network, comprising:
a) a plurality of CPE-CBSDs deployed at fixed positions within the fixed wireless network, wherein the fixed positions of the plurality of CPE-CBSDs allow for allocating resources within the fixed wireless network by optimizing the network resources in terms of beamforming, fractional frequency reuse (FFR), power control and other resource allocation methods available within the fixed wireless network;
b) a BTS-CB SD, connected to and in communications with the plurality of CPE-CBSDs, wherein the BTS-CBSD measures the interference impact, offered load, throughput, and threshold to assess the demand or capacity of the plurality of CPE-CBSDs, and
c) a resource allocation mechanism, coupled to the BTS-CBSD, wherein the resource allocation mechanism inputs information received from both the plurality of CPE-CBSDs and the BTS-CBSD to accurately and efficiently make resource allocation determinations based on the received inputs.

2. The apparatus of claim 1, wherein the resource allocation mechanism is external to the fixed wireless network and comprises a centralized-based device.

3. The apparatus of claim 2, wherein the fixed wireless network is deployed as an Enterprise Network (EN), and wherein the external centralized-based device comprises an SON.

4. The apparatus of claim 1, wherein the plurality of CPE-CBSDs and the BTS-CBSD provide information to the resource allocation mechanism to enable the resource allocation mechanism to make the resource allocation determinations.

5. The apparatus of claim 4, wherein information provided by the plurality of CPE-CBSDs and the BTS-CBSD allow the resource allocation mechanism to determine the following:
(a) which UE attached to a selected CPE-CBSD can be adequately served given current resource allocation conditions;
(b) which fixed CPE-CBSDs can be served in a certain manner given the current resource allocation conditions;
(c) whether fractional frequency reuse (FFR) can be performed;
(d) whether or not beamforming may be performed; and
(e) whether reuse of special diversity based mechanisms can be used by scheduled selected users.

6. A method of allocating resources and spectrum provided by a SAS/SON to a BTS-CBSD, wherein the BTS-CB SD is part of a wireless communications network, and wherein the network also includes a SAS/SON and a plurality of CPE-CBSDs in communication with both the BTS-CBSD and a plurality of user equipment (UE) users, comprising the steps of:
a) determining an amount of contention for WiFi resources, wherein the resources are needed to allow a selected CPE-CBSD to communicate over WiFi to each of a plurality of UEs attempting to access a network through the BTS-CBSD;
b) determining a number of users attempting to access the network through the BTS-CBSD and through each of a plurality of CPE-CBSDs;
c) determining a number of CPE-CBSDs attempting to provide access to the BTS-CBSD for the plurality of UEs;
d) determining an amount of spectrum available to be allocated to the BTS-CBSD by the SAS/SON;
e) determining achieved throughput on a downlink (DL) from the BTS-CBSD to each of the plurality of CPE-CBSDs;
f) determining achieved throughput on a uplink (UL) from the BTS-CBSD to each of the plurality of CPE-CBSDs;
g) determining achieved latency between the BTS-CBSD and each of the plurality of CPE-CBSDs; and based upon the determinations made in steps a) through g);
h) determining whether to change the amount of resources allocated to the BTS-CSBD, and based on the resources allocated to the BTS-CBSD, determining a number of users and flows that can be supported by the CPE-CBSD; and
restricting the admitted users based on accommodatable capacity at the CPE-CBSD.

7. A method of optimizing allocation of spectrum provided by a SAS/SON to a CBSD, comprising the steps of:
(a) determining an amount of contention for WiFi resources, wherein the resources are needed to allow a CPE to communicate over a WiFi channel to each of a plurality of UEs attempting to access a network through the CBSD;
(b) determining a number of users attempting to access the network through the CBSD through each of a plurality of CPEs;
(c) determining a number of CPEs that are attempting to provide access to the CB SD for the plurality of UEs;
(d) determining an amount of spectrum available to be allocated to the CBSD by the SAS/SON;
(e) determining achieved throughput on a downlink from the CBSD to each of the plurality of CPEs;
(f) determining achieved throughput on a uplink from the CB SD to each of the plurality of CPEs;
(g) determining achieved latency between the CBSD and each of the plurality of CPEs; and
(h) based on the determinations made in the steps (a) through (g), determining whether to change the amount of resources allocated to the CSBD.
